(19) United States
(12) Patent Application Publication
(10) Pub. No.: US 2011/0253880 A1
(43) Pub. Date: Oct. 20, 2011

(54) Optical Reader Having Enhanced Two-Dimensional Resolution

(76) Inventors: Mark Francis Krol, Painted Post, NY (US); Robert Adam Modavis, Painted Post, NY (US)

(21) Appl. No.: 12/908,421

(22) Filed: Oct. 20, 2010

Related U.S. Application Data
(60) Provisional application No. 61/253,692, filed on Oct. 21, 2009.

(51) Int. Cl. H01J 40/14; G01B 11/02

(52) U.S. Cl. 250/200; 250/453.11

(57) ABSTRACT

An optical reader system and method for label-independent detection having enhanced two-dimensional spatial resolution of the reader, as defined herein. The system includes a translatable slit-mask and microplate combination for selectively irradiating a biosensor on a microplate, as defined further herein.

### CLAIMING BENEFIT OF PRIOR FILED U.S. APPLICATION

This application claims the benefit of U.S. Provisional Ser. No. 61/253,692, filed on Oct. 21, 2009. The content of this document and the entire disclosure of any publication, patent, or patent documents mention herein are incorporated by reference.

### BACKGROUND

The disclosure generally relates to a microplate article, an apparatus, and method having enhanced two-dimensional (2D) spatial resolution of an optical reader.

### SUMMARY

The disclosure provides a microplate article, a compact microplate optical reader apparatus, and method having enhanced two-dimensional (2D) spatial resolution of a compact optical reader.

### BRIEF DESCRIPTION OF THE DRAWING(S)

In embodiments of the disclosure:

FIG. 1 shows an unmasked grating sensor having a signal region and a reference region.

FIG. 2 shows a masked grating sensor having an exemplary narrow diagonal slit which partially reveals the signal region and partially reveals the reference region of the sensor.

FIG. 3 shows an alternative slitted-masked grating sensor having a horizontal slit which reveals only the signal region or only the reference region of the sensor depending upon the translated location of a movable slitted-mask.

FIG. 4A shows the horizontal slitted-mask of FIG. 3 vertically traversing the grating sensor.

FIG. 4B shows the horizontal slitted-mask of FIG. 3 vertically traversing the grating sensor and including a reference region.

FIG. 5 shows in exploded assembly a microplate having an array of grating sensors and an adjacent movable mask having an array of slits.

FIG. 6 shows a graph comparing actual experimental results (dots) with expected theory (solid line) for radiation wavelengths received (i.e., read) from the masked sensor as a function of the distance across the sensor in the revealed regions, that is, as measured for the diagonal slit region of FIG. 2.

FIG. 7 shows an exemplary image obtained from a microplate having a 200 micrometer width slit-mask vertically across each of 16 columns of wells of the microplate.

FIG. 8 shows an exemplary detected intensity profile in which the spectral resonance is convolved with the well dimension.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments for the claimed invention.

### DEFINITIONS

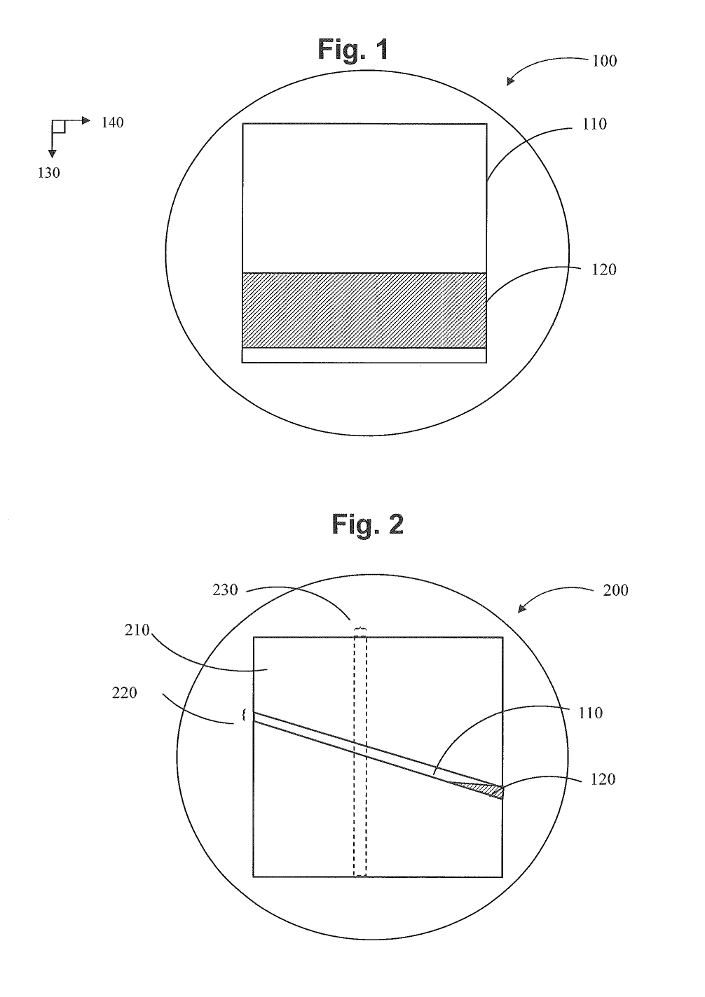

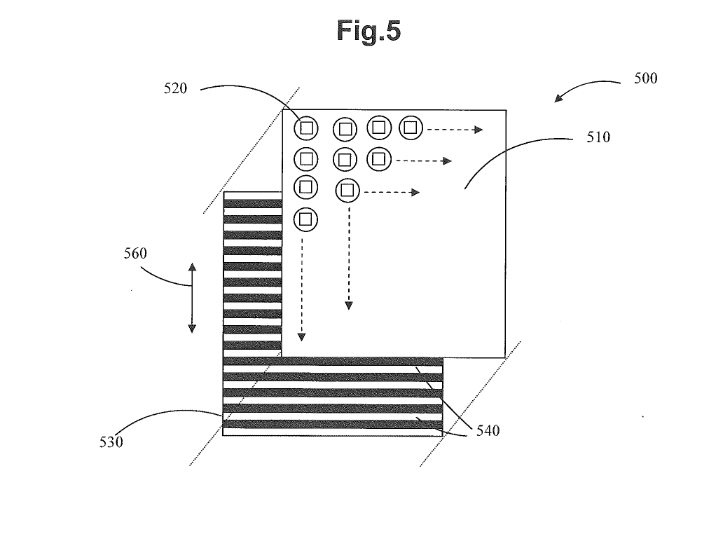

“Slit,” and like terms refer to, for example, a narrow opening or aperture (e.g., rectangular) in a mask member which can limit the exposure in the dispersive-direction of an underlying sensor and to permit substantially full exposure in the perpendicular dimension of the underlying sensor. The relative ratio of length to width (L:W) dimensions of the narrow slit can be, for example, 1.5:1, 2:1, 3:1, 4:1, 5:1, 6:1, 7:1, 8:1, 9:1, 10:1, 50:1, 100:1, 1,000:1, 10,000:1, 100,000:1, including intermediate values and ranges. An example slit is shown (not drawn to scale) in FIGS. 2 (220), 3 (320), and 4 (420). FIG. 5 shows an example of a slitted-mask having a plurality of slits (540) in or on the mask member (530).

“Slitted-mask” and like terms refer to, for example, a mask for concealing substantially the entire surface of a sensor and having at least one slit to selectively reveal a portion of the surface of a sensor.

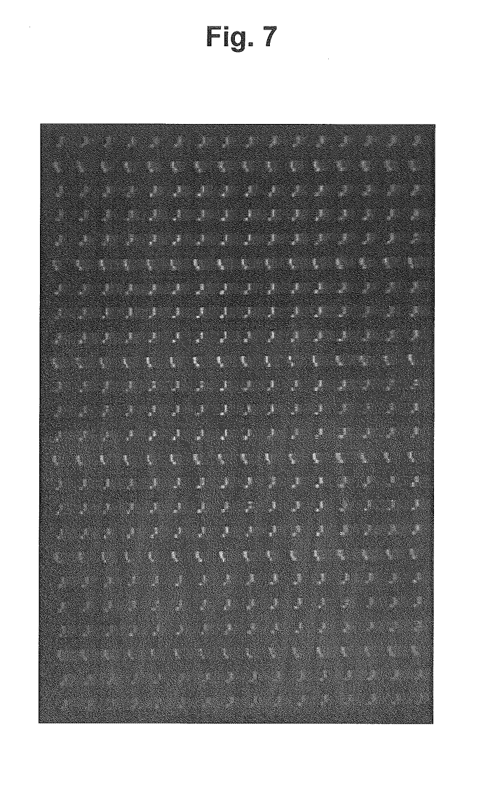

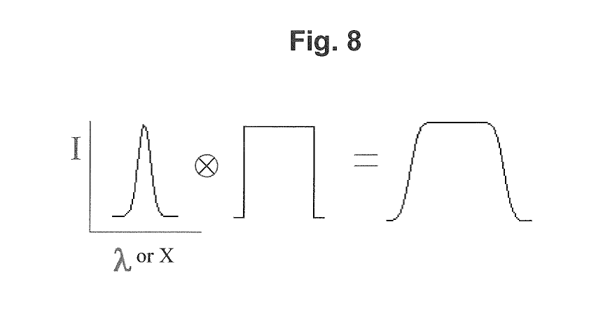

“Dispersive-direction” and like terms refer to, for example, a grating, or like component such as a prism, that separates or disperses a radiation beam into its constituent wavelength components, and the direction of the separation or dispersion is perpendicular to the spatial direction. As shown in FIG. 7, the dispersive direction is readily apparent in the still-shot image where, for example, image detail in the dispersive-direction (left-to-right) appears smeared or blurry and image detail in the spatial-direction (top-to-bottom) appears sharp or clear and in-focus.

“Biosensor” or like term refers to an article, that in combination with appropriate apparatus, can detect a desired analyte. A biosensor can combine a biological component with a physicochemical detector component. A biosensor can typically consist of three parts: a biological component or element (such as tissue, microorganism, pathogen, cells, cell component, a receptor, and like entities, or combinations thereof), a detector element (operating in a physicochemical way such as optical, piezoelectric, electrochemical, thermometric, magnetic, or like manner), and a transducer associated with both components. In embodiments, the biosensor can convert a molecular recognition, molecular interaction, molecular stimulation, or like event occurring in a surface bound cell component or cell, such as a protein or receptor, into a detectable and quantifiable signal. A biosensor as used herein can include liquid handling systems which are static, dynamic, or a combination thereof. In embodiments of the disclosure, one or more biosensor can be incorporated into a micro-article.

Commonly owned and assigned copending U.S. Patent Application Publication 2007/0154356 (U.S. Ser. No. 11/436,923) (R. Modavis) discloses at para. [0042] an optically readable microplate having an attached mask with apertures. The mask layer or agent with apertures blocks transmitted light. U.S. Patent Publication 2003/0059855 (Cunningham) discloses a microfilter tray 456, plate tray 458, and incubation assembly bottom portion 602. Neither publication provides for relative motion of a slitted-mask and a biosensor nor a narrow-width slit-biosensor to accomplish enhanced 2D resolution in an optical reader.

Biosensors are useful tools and some exemplary uses and configurations are disclosed, for example, in PCT Application No. PCT/US2006/013539 (Pub. No. WO 2006/108183), published Dec. 10, 2006, to Fang, Y., et al., entitled “Label-Free Biosensors and Cells,” and U.S. Pat. No. 7,175,980. Biosensor-based cell assays having penetration depths, detection zones, or sensing volumes have been described, see for example, Fang, Y., et al. “Resonant waveguide grating biosensor for living cell sensing,” Biophys. J., 91, 1925-1940 (2006). Microfluidic articles are also useful tools and some exemplary uses, configurations, and methods of manufacture are disclosed, for example, in U.S. Pat. Nos. 6,677,131, and 7,007,709. U.S. Patent Publication 20070141231 and U.S. Pat. No. 7,175,980, disclose a microplate assembly and method. The compositions, articles, and methods of the disclosure are particularly well suited for biosensors based on label-independent detection (LID), such as for example an Epic® system or those based on surface plasmon resonance (SPR). The compositions, articles, and methods of the disclosure are also compatible with Dual Polarized Intereferometry (DPI), which is another type of LID sensor. In embodiments, the biosensor system can comprise, for example, a swept wavelength optical interrogation imaging system for a resonant waveguide grating biosensor, an angular interrogation system for a resonant waveguide grating biosensor, a spatially scanned wavelength interrogation system, surface plasmon resonance system, surface plasmon resonance imaging, or a combination thereof.

A preferred optical system is a constant stare imager (constant stare imager). The surface of the biosensor can be, for example, an uncoated surface such a glass or plastic or for example, a coated surface. Suitable surface coatings for the biosensor can include, for example, fibronectin, collagen, gelatin, poly-D-lysine, a synthetic polymer, and like coating compositions, and mixtures thereof. The coating composition can be used as a thin film, for example, on certain Epic® biosensor well-plate products commercially available from Corning, Inc. In embodiments, the coating of the coated biosensor can have “reactive groups” and “ionizable groups” and which groups refer to moieties that can chemically react and moieties than can ionize, respectively, and as defined in commonly owned, copending U.S. Ser. No. 12/273,147, filed Nov. 18, 2008, and commonly owned and assigned copending U.S. Ser. No. 11/973,832, filed Oct. 10, 2007. Another suitable surface coating is disclosed in commonly owned, copending U.S. Ser. No. 11/448,486, filed Jun. 7, 2006. Another suitable surface coating can be, for example, an ethylene-maleic anhydride (EMA) polymer according to T. Pompe (Pompe, et. al, “Functional Films of Maleic Anhydride Copolymers under Physiological Conditions,” Macromol. Biosci., 2005, 5, 890-895). The polymer can be, for example, a polyacrylic acid polymer, or copolymer containing acrylic acid monomers. The polymer can be, for example, a carboxylated polysaccharide or like materials as disclosed, for example, in U.S. Pat. Nos. 5,242,828 and 5,436,161.

“Include,” “includes,” or like terms means encompassing but not limited to, that is, inclusive and not exclusive.

“About” modifying, for example, the quantity, dimension, process temperature, process time, and like values, and ranges thereof, employed in describing the embodiments of the disclosure, refers to variation in the numerical quantity that can occur, for example: through typical measuring and handling procedures used; through inadvertent error in these procedures; through differences in the manufacture, source, or quality of components and like considerations. The term “about” also encompasses amounts that differ due to aging of or environmental effects on components. The claims appended hereto include equivalents of these “about” quantities.

“Optional,” “optionally,” or like terms refer to the subsequently described event or circumstance can or cannot occur, and that the description includes instances where the event or circumstance occurs and instances where it does not. For example, the phrase “optional component” or like phrase means that the component can or can not be present and that the disclosure includes both embodiments including and excluding the component.

“Consisting essentially of” in embodiments refers, for example, to optical readers and associated components, to an assay, to method of using the assay to screen compounds, and to articles, devices, or any apparatus of the disclosure, and can include the components or steps listed in the claim, plus other components or steps that do not materially affect the basic and novel properties of the articles, apparatus, or methods of making and use of the disclosure, such as particular components, a particular light source or wavelength, a particular surface modifier or condition, or like structure, material, or process variable selected. Items that may materially affect the basic properties of the components or steps of the disclosure or that may impart undesirable characteristics to aspects of the disclosure include, for example, having a disfavored orientation for the slit and movement of the slit relative to the motion between the microplate and the mask that is parallel to the dispersive direction of the angularly separated radiation.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, times, operations, and like aspects, and ranges thereof, are for illustration only; they do not exclude other defined values or other values within defined ranges. The article, apparatus, and methods of the disclosure include those having any value or any combination of the values, specific values, more specific values, and preferred values described herein.

In embodiments, the disclosure provides an article, an apparatus, and a method for improving two-dimensional resolution of an optical reader for biochemical and live-cell based label-independent-detection assays.

In embodiments, the issue of two-dimensional image resolution in a compact optical reader apparatus can be accomplished and further enhanced by, for example, using the spatial information in both the dispersive-direction and in the perpendicular-direction (i.e., non dispersive-direction). Spatial information in the dispersive direction of the disclosed optical reader system is convolved with the shape of the sensor's resonance as shown in FIG. 8. As a result, small spatial details in the dispersive direction are largely obscured. However, spatial information is preserved in the perpendicular direction. The disclosure provides a microplate article, an optical reader apparatus, and a method of use having improved two-dimensional image resolution.

In the disclosed optical reader system, spatial resolution can be obtained in one direction (i.e., the non dispersive-direction), and in another perpendicular direction to the non dispersive-direction (i.e., the dispersive-direction) spatial details can be convolved with the spectral resonances at each point. In the dispersive-direction spatial information and spectral information about a microplate well and biosensor can be combined in the data obtained. With an optical reader or like reader system it may be desirable to obtain spatial detail in both directions. Two exemplary methods are described for enhancing the spatial resolution of the disclosed optical reader system.

In embodiments, the optical reader can be, for example, as disclosed in commonly owned and assigned copending application U.S. Ser. No. 61/253,679 (filed concurrently herewith) entitled “COMPACT OPTICAL READER SYSTEM.”

In embodiments, advantages of the disclosed methods and apparatus include that they can, for example, enable spatial information to be obtained with the optical reader system in the dispersive-direction. The dispersive-direction spatial information can be combined with the spatial information already obtained with the reader in the perpendicular direction to the dispersive direction to permit two-dimensional (2D) spatial resolution.

In embodiments, the disclosure provides a method for enhancing the spatial resolution of the optical reader comprising providing a slit on the face of a masked sensor to limit the dimension of the sensor in the dispersive direction. Advantages of this arrangement include, for example, i) an existing 2×2 mm sensor can be used, and ii) the slit can be translated or moved to a new location relative to the sensor surface after each imaging measurement and before reimaging in the new location so that most or all of the entire sensor surface area can be continuously or sequentially imaged. In this manner two dimensional resolution of the entire sensor can be obtained.

In embodiments, the disclosure provides an optical reader system comprising:

a receptacle for receiving at least one optical biosensor article, such as a multi-well microplate;

a slitted-mask adjacent to the receptacle to substantially conceal the surface of the biosensor article and at least one slit across a portion of the face of the mask to selectively reveal the surface of the biosensor article;

a radiation source and radiation receiver having an angular separator; and

a mover for selective relative motion between the biosensor article and the slitted-mask, and the relative motion of the slit is perpendicular to the dispersive direction of the angularly separated radiation.

A mover for selective relative motion can be, for example, any means for causing controllable relative motion between the microplate and the slit mask. In embodiments, the slit can be translated relative to the sensor surface by, for example, moving the mask in close proximity to a stationary sensor (i.e., well microplate), moving the sensor in close proximity to a stationary mask, moving the mask and sensor, and like permutations. The mover movement satisfies a first condition of moving the mask relative to the biosensor article when the article resides in the receptacle, and satisfies a second condition where the movement of the first condition also provides relative movement of the slit that is perpendicular to the dispersive direction of the angularly separated radiation. A disfavored orientation for the slit and movement of the slit relative to the motion between the microplate and the mask is perpendicular to the dispersive direction of the angularly separated radiation.

The optical reader system can further comprise a microplate having at least one well, the well having at least one optical biosensor therein, the at least one optical biosensor having at least one sample therein, and the biosensor having a signal region and a reference region. The sample can be, for example, any substance of interest for analysis such as a cell, a biological, a compound, a polymer, and like materials, or combinations thereof. The microplate can comprise, for example, an array of wells having a biosensor in the well, and the mover can be, for example, at least one servo motor, that can be computer numerically controlled (CNC) or like control methods, which can systematically translate, stepwise or continuously, the slitted-mask across the array of wells relative to the microplate. The at least one slit across the face of the mask can be, for example, horizontal, vertical, diagonal, or a combination thereof with respect to an edge of the mask.

In embodiments, the slitted-mask can be, for example, a single slit across a portion of the mask, or a single slit across the entire mask, including intermediate lengths, so as to include or encompass at least a portion of the at least one of the biosensors on the microplate. In embodiments, the slitted-mask can be, for example, a single slit or a plurality of regularly spaced parallel slits, which slit(s) can span(s) two or more wells of the microplate. In embodiments, the slitted-mask can be, for example, a plurality of regularly spaced parallel slits. In embodiments, the slitted-mask can be constructed from, for example, a thin sheet of transparent material, such as glass, plastic, composite, or like material, and the transparent sheet can be selectively opaqued (e.g., with paint, ink, tape, metalized coating, or like surface treatments) with a slit or slits being formed in non-opaqued areas. In embodiments, the slitted-mask can be constructed from, for example, a thin sheet of opaque material, such as glass, plastic, composite, or like material, and the opaque sheet can be selectively machined or etched, for example, with a laser, to create a slit or slits as a pass-through or aperture in the opaque sheet.

In embodiments, the optical reader system can provide, for example, a spatial resolution of from about 100 by about 200 micrometers. Alternative spatial resolutions can be achieved, for example, of from about 10 by about 500 micrometers, including intermediate values and ranges, depending upon the reader configuration. The disclosed reader apparatus and method can increase spatial resolution to about 500 to about 10 micrometers, where a smaller value equates to greater improvement in spatial resolution.

In embodiments, the disclosure provides a method of reading a microplate in a label independent detection optical reader system comprising:

providing the optical reader system comprising:
a receptacle for receiving at least one optical biosensor article, such as a fluid-tight multi-well microplate;
a slitted-mask adjacent and in close proximity to the receptacle to substantially conceal the surface of the biosensor article, and at least one slit across a portion of the face of the mask to selectively reveal the surface of the biosensor article;
a radiation source having an angular separator, and
a mover for selective relative motion between the biosensor article and the slitted-mask, and the relative motion of the slit is parallel to the dispersive direction of the angularly separated radiation;

forming a masked microplate assembly by engaging the receptacle with a microplate having at least one well, the well having at least one biosensor, and the at least one biosensor having at least one sample therein;

irradiating the masked microplate assembly with angularly separated radiation with the slit at a first location; and

recording the radiation transmitted from the irradiated masked microplate assembly.

In embodiments, the method can further comprise moving the microplate relative to the slitted-mask to a second location and irradiating the masked microplate assembly at a second location. The moving, irradiating, and recording can be successively repeated to cover a series of different locations, for example, a selected biosensor or well, or a selected row of wells or column of wells.

The relative movement of the microplate with respect to the slitted-mask can be, for example, moving the mask while the microplate maintains a fixed position, moving the microplate while the mask maintains a fixed position, or a combination thereof, such as systematically moving both the mask and the microplate. The relative movement of the microplate and the slitted mask can include, for example, translating the at least one slit stepwise across the entire surface area of the biosensor. The relative movement of the microplate and the slitted mask can include, for example, translating the at least one slit continuously across the entire surface area of the biosensor. Masks having multiple slits such as shown in FIG. 5 (530) and (540) are contemplated. Additionally or alternatively, the relative movement of microplate with respect to a mask having multiple slits, such as one slit for each row or column of wells, can also be accomplished, for example, stepwise or continuously, The translating can be accomplished, for example, parallel to the dispersive-direction of the angularly separated radiation. In embodiments, the method of reading a microplate increases spatial resolution by from about 2 millimeters to about 10 micrometers for a well having a dimension of about 2 millimeters.

### EXAMPLES

The following examples serve to more fully describe the manner of using the above-described disclosure, as well as to further set forth the best modes contemplated for carrying out various aspects of the disclosure. It is understood that these examples do not limit the scope of this disclosure, but rather are presented for illustrative purposes. The working examples further describe how to make and use the methods of the disclosure.

### Example 1

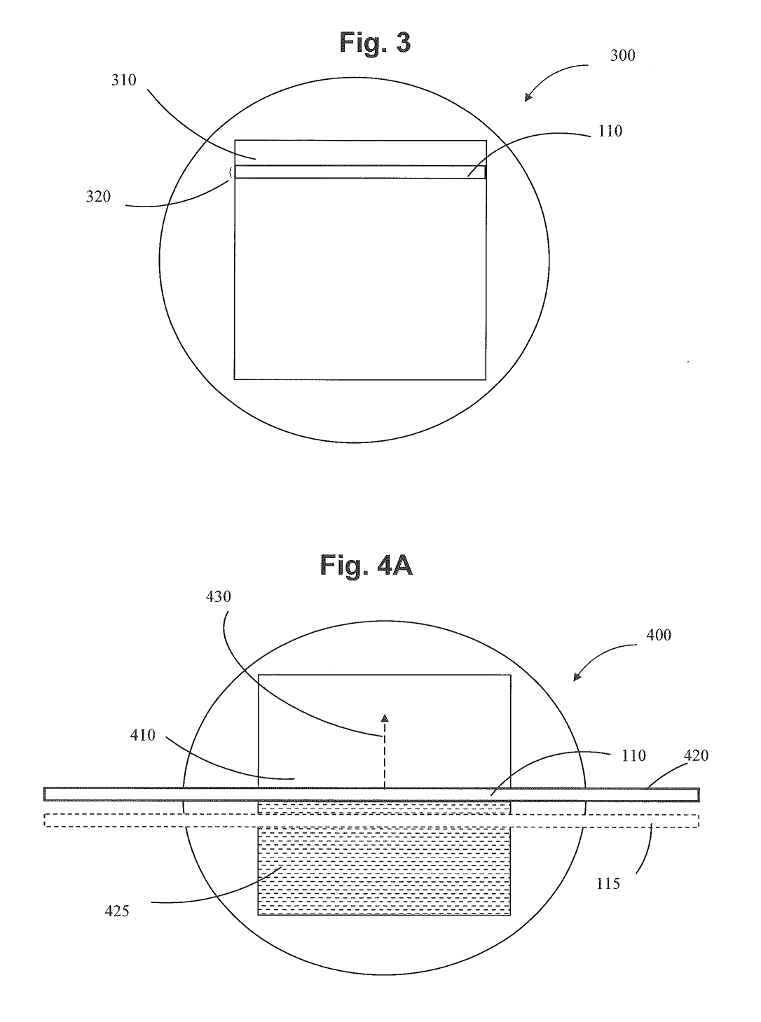

Measurement with Slitted-Mask A demonstration of the disclosed resolution method included an experiment using a stationary slit. For this experiment a microplate sensor with a reference pad as shown in FIG. 1 was used. FIG. 1 shows an exemplary well in a well plate having an unmasked grating sensor (100) having, for example, an area of 2×2 mm, having a signal region (110) and a reference region (120). Reference numerals (130) and (140) represent the dispersive-direction and the perpendicular direction, respectively. Next, a slit having a width of about 200 micrometers was constructed, for example, with two parallel pieces of opaque tape applied to the underside of the base insert, or for example, an opaque media such as ink or paint applied to a transparent sheet, such as glass, plastic or like materials, to conceal all but a narrow region (i.e., slit) of the microplate sensor as shown in FIG. 2. FIG. 2 shows the masked grating sensor (200) having a mask (210) which mask substantially conceals the underlying sensor area and an exemplary narrow diagonal slit (220) which partially reveals the signal region (110) and partially reveals the reference region (120) of the sensor. The illustrated slitted-masked grating sensor (not drawn to scale) can have the narrow diagonal slit (220) and the slit can have a slit-width of, for example, about 200 micrometers. As noted elsewhere the orientation of the slit can be vertical (230) or horizontal (not shown; see FIG. 3) with respect to an edge of the mask or an edge of the sensor so long as the slit orientation is not parallel to the dispersive direction.

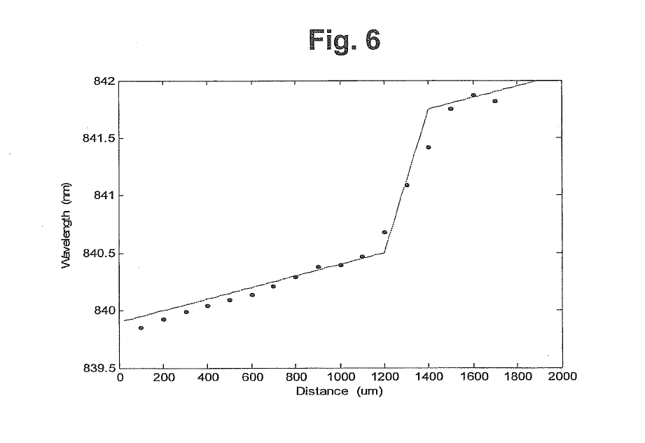

With this configuration, a wavelength measurement was made for a series of sequential vertical slices across the sensor. Each slice can be separated by, for example, about 100 micrometers and recorded as a digital image by a CCD camera. Each image slice can be one of the well column as shown in FIG. 8. Here the vertical direction is the dispersive direction. The expected result for these slices, progressing from left to right, is to observe a linear increase in wavelength, as determined by the angle of the slit across the well, followed by a jump in wavelength (equal to the delta wavelength between the signal and reference region), and then a linear increase of the same slope as before the transition. FIG. 6 shows a graph that compares actual experimental results (dots) with expected theory (solid line) for radiation wavelengths received (i.e., read) from the sensor as a function of the distance across the sensor in the revealed regions, that is, as measured for the diagonal slit region of FIG. 2. The measured points (dots) and the expected result (solid line) shown in FIG. 6 assume a wavelength shift of 1.15 nm between the signal region and the reference region. There is very good agreement between the experimental and theoretical results. This result demonstrates that a spatial resolution of approximately 100×200 micrometers can be achieved. Even higher spatial resolution can be expected if a narrower slit (i.e., smaller effective pixel sizes) is selected.

FIG. 3 shows an alternative slitted-masked grating sensor (300) that is analogous to the slitted-masked grating sensor of FIG. 2 with the exception of having a horizontally oriented slit (320) that reveals only the signal region (110) or only the reference region (not shown) of the sensor depending upon the translated location of a movable slitted-mask (310).

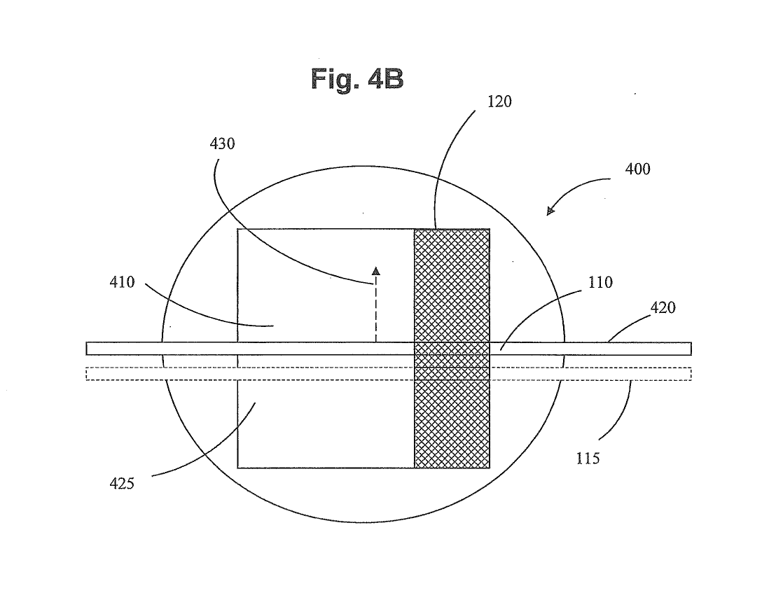

FIG. 4A shows another embodiment of a horizontally oriented slitted-mask (400) such as shown in FIG. 3 that can vertically traverse (430) the concealed grating sensor or is traversed (430) by the concealed grating sensor depending upon the relative motion of the mask and sensor. The horizontally slitted-mask (420) (i.e., the slit) can be translated vertically (430) to reveal a new portion of the sensor region (110) from a previously revealed portion of the sensor region (115) so that all or a portion of the underlying sensor surface (425) is incrementally imaged according to the disclosed optical reading method. FIG. 4B shows a further embodiment where FIG. 4A is further modified to include both a signal region and a vertically oriented reference region (120).

FIG. 5 shows in exploded assembly view an exemplary slitted-masked sensor concept (500) having a microplate (510) having an array (represented by the dotted arrows) of wells having one or more grating sensors (520) and an adjacent movable mask (530) having an array of slits (540). The movable mask (530) can be translated relative to the microplate, for example, vertically (560) as shown. Alternatively, the mask (530) can be translated horizontally (not shown) if both the mask (530) and the angular separator (e.g., transmission grating; not shown) are rotated ninety (90) degrees. The relative translation of the microplate and slitted-mask member can be accomplished by, for example, a translation stage.

The foregoing example can be accomplished using any of the alternative reader configurations, materials, or methods mentioned herein including repeatedly obtaining wavelength measurements for a series, such as sequentially or stepwise (e.g., repeating stop-start-stop sequence having discrete read positions) or continuously (e.g., non-stop), of different locations on the biosensor surface with relative motion between the slitted mask and the well plate between each measurement.

The disclosure has been described with reference to various specific embodiments and techniques. However, it should be understood that many variations and modifications are possible while remaining within the spirit and scope of the disclosure.

What is claimed:

1. An optical reader system comprising:
a receptacle for receiving at least one optical biosensor article;
a slitted mask adjacent to the receptacle to substantially conceal the surface of the biosensor article and at least one slit across a portion of the face of the mask to selectively reveal the surface of the biosensor article;
a radiation source having an angular separator; and
a mover for selective relative motion between the microplate and the slitted mask, and the relative motion of the slit is parallel to the dispersive direction of the angularly separated radiation.

2. The optical reader system of claim 1 further comprising a microplate having at least one fluid-tight well, the well having at least one optical biosensor therein, and the biosensor having a signal region, a reference region, or a combination thereof.

3. The optical reader system of claim 2 wherein the microplate comprises an array of wells, and the mover comprises at least one servo motor that translates, stepwise or continuously, the slitted-mask across the array of wells relative to a stationary microplate.

4. The optical reader system of claim 1 wherein the at least one slit across the face of the mask is horizontal, vertical, diagonal, or a combination thereof with respect to an edge of the mask.

5. The optical reader system of claim 1 wherein the slitted mask comprises a plurality of parallel slits.

6. The optical reader system of claim 1 wherein the reader system provides spatial resolution of from about 100 by about 200 micrometers.

7. A method of reading a microplate in a label independent detection optical reader system comprising:
providing the optical reader system of claim 1;
forming a masked microplate assembly by engaging the receptacle with a microplate having at least one well, the well having at least one biosensor, and the at least one biosensor having at least one sample therein;
irradiating the masked microplate assembly with angularly separated radiation with the slit at a first location; and
recording the radiation transmitted from the irradiated masked microplate assembly.

8. The method of claim 7 wherein the method increases spatial resolution to about 500 to about 10 micrometers.

9. The method of claim 7 further comprising moving the microplate relative to the slitted mask to a second location, irradiating the masked microplate assembly at the second location, recording the transmitted radiation, and repeating the steps of moving, irradiating, and recording, from 1 to about 1,000 times.

10. The method of claim 9 wherein the relative movement of the microplate and the slitted mask comprises translating the at least one slit stepwise across the entire surface area of the biosensor.

11. The method of claim 9 wherein the relative movement of the microplate and the slitted mask comprises translating the at least one slit continuously across the entire surface area of the biosensor.

12. The method of claim 10 wherein the translating is accomplished perpendicular to the dispersive direction of the angularly separated radiation.

13. The method of claim 7 wherein the sample comprises a cell, a live-cell, a cell construct, a biological, a virus, a prion, a therapeutic compound, an agonist, an antagonist, or a combination thereof.
